(19) United States
(12) Patent Application Publication
(10) Pub. No.: US 2025/0388031 A1
(43) Pub. Date: Dec. 25, 2025

(54) PLATEN WITH SHIRT TAG AREA ENHANCEMENT AND METHOD FOR USE THEREOF

(71) Applicant: Brian A. Walker, New Philadelphia, OH (US)

(72) Inventor: Brian A. Walker, New Philadelphia, OH (US)

(21) Appl. No.: 19/248,074

(22) Filed: Jun. 24, 2025

Related U.S. Application Data
(60) Provisional application No. 63/663,851, filed on Jun. 25, 2024.

(51) Int. Cl. B41J 11/06; B41J 3/407; D06P 5/00

(52) U.S. Cl. CPC B41J 11/06; B41J 3/4078; D06P 5/002

(57) ABSTRACT

A platen facilitating enhancement of an inside label/tag area to facilitate operations thereon during a printing process is provided. The platen includes a body portion on which a chest/abdomen area of a garment can be supported, and at least one extension portion on which the inside label/tag area of the garment can be supported. The platen affords application of a pretreatment liquid, inks, and/or dyes to the chest/abdomen area and the inside label/tag area of the garment without having to reposition the garment during such application.

The present application claims the benefit of U.S. Provisional Application No. 63/663,851, filed Jun. 25, 2024; all of which is incorporated by referenced herein.

### FIELD

The present technology generally relates to a platen for use with a pretreatment-application machine and/or a printing device to afford efficient application of a pretreatment liquid, inks, and/or dyes to portions of a garment supported by the platen.

### BACKGROUND

Conventional platens have been used in garment printing processes to move a garment from one station of a printing process to another station. The conventional platens are usually flat board portions that provide a backing to and a structure on which a garment can be supported, and when supported thereby, the conventional platens and the garments can be moved between various equipment, machines, and/or stations. Traditionally, the conventional platens were used to facilitate movement of the garments between different color application stations of a multi-station screen-printing machine, while creating solid surfaces against which the garments are provided so that ink, dyes, and pretreatment can be effectively applied thereto. These conventional platens could be integrated with or releasably attached to a portion of the multi-station screen-printing machine, so that garments received over the platens can be moved between stations thereof. The different equipment, machines, and/or stations of the multi-station screen-printing machine could correspond to different colors and/or also include, for example, pretreatment application machines, drying stations, and cooling stations. Saving time in the garment printing processes is of paramount concern, and recently, tagless garments without physical tags have become the industry standard. Instead of such physical tags, tagless garments include a printed label or tag. As such, tagless garments will typically have printing provided on both exterior and interior portions of the garments. However, using the conventional platens, garments will usually require positioning and repositioning thereon to print on both of the exterior and interior portions. To illustrate, each of the garments will usually require positioning in a first position to effectuate printing on an exterior portion thereof, and then repositioning in a second position to effectuate printing on an interior portion thereof, or vice versa. Such positioning and repositioning takes extra time, and thus, there is a need for an improved platen that can facilitate positioning of a garment thereon in a single position to afford application of pretreatment and/or printing on both exterior and interior portions of the garment. The improved platen can be used in moving the garment between equipment, machines, and/or stations of a printing process to afford application of a graphic to both the exterior and interior portions of the garment.

### SUMMARY

The techniques of this disclosure generally relate to a platen for use with a pretreatment-application machine and/or a printing device to afford efficient application of a pretreatment liquid, inks, and/or dyes to portions of a garment supported by the platen.

In one aspect, the present disclosure provides a platen facilitating enhancement of a shirt label/tag area, the platen including a first end, an opposite second end, a first side extending between the first end and the second end, and a second side extending between the first end and the second end; a body portion extending from the first end toward the second end of the platen, the body portion including an upper surface, a first edge portion positioned at the first end of the platen, and a second edge portion positioned between the first end and the second end of the platen; a middle extension portion attached to the body portion and extending from the second end of the platen toward the body portion, the middle extension portion including an upper surface, a first edge portion opposite from the second edge portion of the body portion, a second edge portion positioned at the second end of the platen, a third edge portion positioned between the first edge portion and the second edge portion, and a fourth edge portion positioned between the first edge portion and the second edge portion; a first-side extension portion attached to the body portion, positioned on a first side of the middle extension portion, the first-side extension portion including a first edge portion opposite from the middle extension portion; a second-side extension portion attached to the body portion, positioned on a second side of the middle extension portion, the second-side extension portion including a first edge portion opposite from the middle extension portion; where the second edge portion of the body portion and the first edge portion of the middle extension portion are spaced apart from one another by a first gap portion, the third edge portion of the middle extension portion and the first edge portion of the first-side extension portion are spaced apart from one another by a second gap portion, and the fourth edge portion of the middle extension portion and the first edge portion of the second-side extension portion are spaced apart from one another by a third gap portion; and where a t-shirt can be placed on the platen with the upper surface of the body portion supporting at least a portion of a chest/abdomen area of the t-shirt, and with the upper surface of the middle extension portion supporting at least a portion of an inside label/tag area of the t-shirt.

In another aspect, the present disclosure provides a platen facilitating enhancement of a shirt label/tag area, the platen including a first end, an opposite second end, a first side extending between the first end and the second end, and a second side extending between the first end and the second end; a body portion extending from the first end toward the second end of the platen, the body portion including an upper surface, a first edge portion positioned at the first end of the platen, and a second edge portion positioned between the first end and the second end of the platen; a middle extension portion attached to the body portion and extending from the second end of the platen toward the body portion, the middle extension portion including an upper surface, a first edge portion opposite from the second edge portion of the body portion, a second edge portion positioned at the second end of the platen, a third edge portion positioned between the first edge portion and the second edge portion, a fourth edge portion positioned between the first edge portion and the second edge portion, and abrupt corners formed at intersections of the first edge portion thereof with the third and fourth edge portions thereof, and intersections of the second edge portion thereof with the third and fourth edge portions thereof; a first-side extension portion attached to the body portion, positioned on a first side of the middle extension portion, the first-side extension portion including a first edge portion opposite from the middle extension portion; a second-side extension portion attached to the body portion, positioned on a second side of the middle extension portion, the second-side extension portion including a first edge portion opposite from the middle extension portion; where the second edge portion of the body portion and the first edge portion of the middle extension portion are spaced apart from one another by a first gap portion, the third edge portion of the middle extension portion and the first edge portion of the first-side extension portion are spaced apart from one another by a second gap portion, and the fourth edge portion of the middle extension portion and the first edge portion of the second-side extension portion are spaced apart from one another by a third gap portion; and where a t-shirt can be placed on the platen with the upper surface of the body portion supporting at least a portion of a chest/abdomen area of the t-shirt, and with the upper surface of the middle extension portion supporting at least a portion of an inside label/tag area of the t-shirt; and where natural elasticity of the t-shirt and interaction thereof with the abrupt corners maintains a position of the t-shirt relative to the middle extension portion.

In yet another aspect, the present disclosure provides a method of using a platen with a shirt label/tag area enhancement, the method including providing the platen having a body portion having an upper surface, a middle extension portion attached to the body portion, a first-side extension portion attached to the body portion and provided on a first side of the middle extension portion, and a second side-extension portion attached to the body portion and provided on a second side of the middle extension portion; supporting the t-shirt on the platen by placing a portion of a chest/abdomen area of the t-shirt on an upper surface of a body portion of the platen and placing a portion of an inside label/tag area of the t-shirt on an upper surface of the middle extension portion of the platen; pushing portions of a collar of the t-shirt into a first gap portion between the body portion and a middle extension portion, into a second gap portion between the middle extension portion and the first-side extension portion, and into a third gap portion between the middle extension portion and the second-side extension portion to expose more of the inside label/tag area to correspondingly enhance a size of the inside label/tag area provided over the upper surface of the middle extension portion; and when the t-shirt is supported on the platen, positioning the platen and the t-shirt positioned thereon in a pretreatment-application machine, and spraying a pretreatment over portions of the chest/abdomen area and the inside label/tag area of the t-shirt using the pretreatment-application machine.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

The techniques of this disclosure generally relate to a platen.

FIG. 1A is a top, perspective view of a platen according to the present disclosure supporting a t-shirt thereon relative to a pretreatment-application machine with a portion of the pretreatment-application machine located in a first position;

FIG. 1B is an enlarged view of FIG. 1A;

FIG. 2 is a top, perspective view of the platen, the t-shirt, and the pretreatment-application machine of FIG. 1A with the portion of the pretreatment-application machine located in a second position;

FIG. 3 is a top, perspective view of the platen, the t-shirt, and the pretreatment-application machine of FIG. 1A with the portion of the pretreatment-application machine located in a third position

FIG. 4 is a top, perspective view of the platen of FIG. 1A;

FIG. 5 is a bottom, perspective view of the platen of FIG. 1A;

FIG. 6 is a top, plan view of the platen of FIG. 1A; and

FIG. 7 is a bottom, plan view of the platen of FIG. 1A.

### DETAILED DESCRIPTION

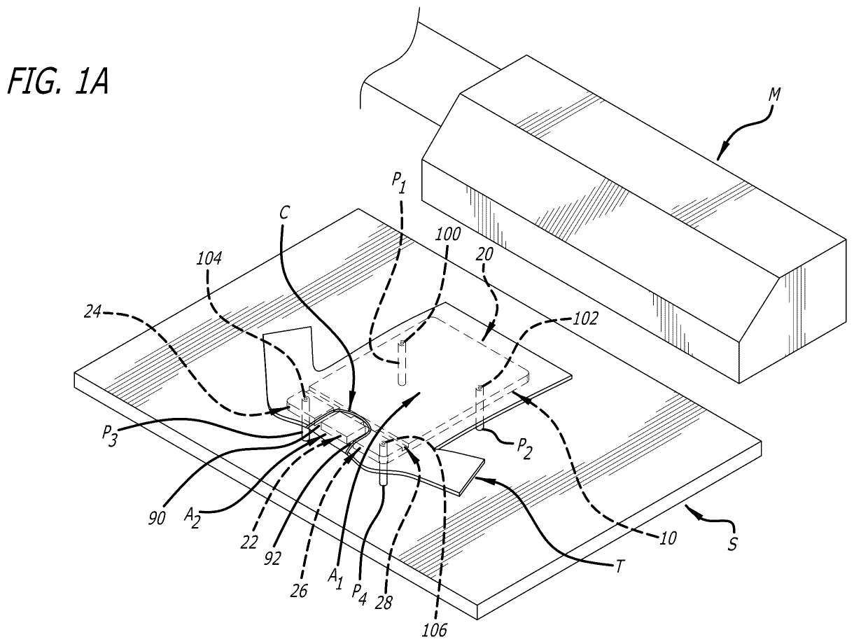

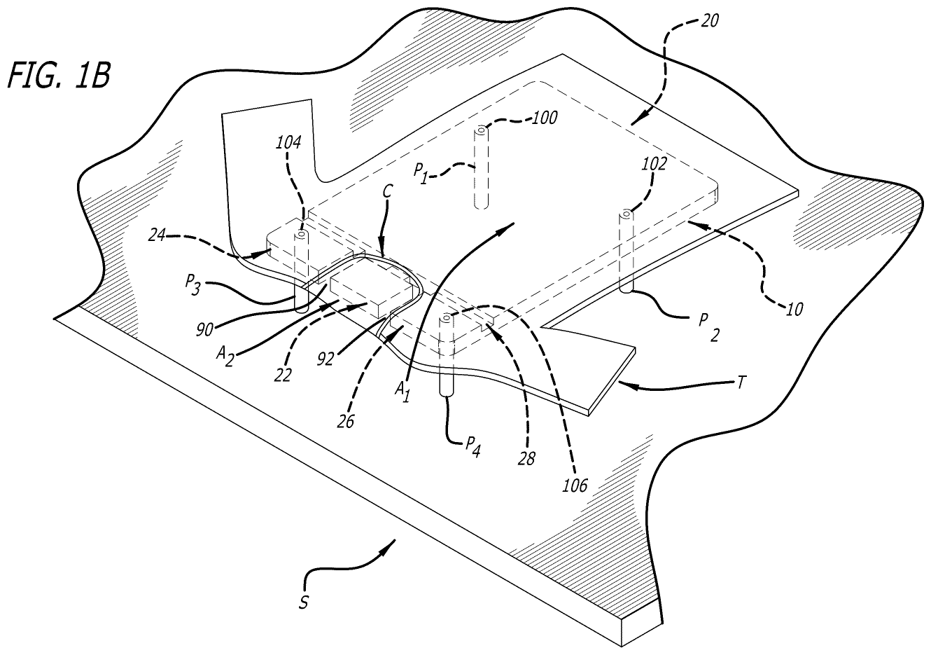

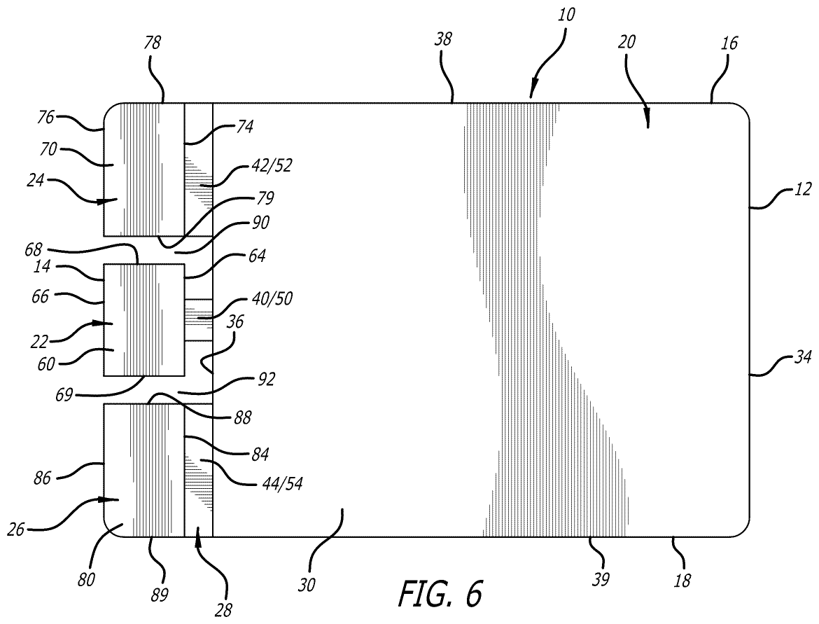

A platen according to an embodiment of the present disclosure is generally referenced by the numeral 10 in FIGS. 1A-7. As discussed below, the platen 10 is utilized to support a garment such as, for example, a t-shirt T. The platen 10 can provide a backing to and a structure on which the t-shirt T can be supported, and when supported thereby, the platen 10 and the t-shirt T can be moved between various equipment, machines, and/or stations of a printing process to facilitate application of graphics to both exterior and interior portions of the t-shirt T. The platen 10 creates a solid surface against which the t-shirt T can be provided, so that ink, dye, and/or pretreatment can be effectively applied thereto during the printing process.

To illustrate, the platen 10 can be used to support the t-shirt T during use of a pretreatment-application machine M, as depicted in FIGS. 1A, 2, and 3, to facilitate application of pretreatment liquid L to the t-shirt T. With the t-shirt provided on and supported thereby, the platen 10 can be supported by a substrate S that can be part of or separate from the pretreatment-application machine M, and a spray nozzle (not shown) of the pretreatment-application machine M can be moved relative to the platen 10 (FIGS. 1A, 2, and 3) and/or the platen 10 can be moved relative to the spray nozzle to apply the pretreatment liquid L to the t-shirt T. As discussed below, the platen 10 is configured to afford efficient application of the pretreatment liquid L to a chest and/or abdomen area A1 and an inside label/tag area A2 of the t-shirt T (where a label or tag can be printed) during use of the pretreatment-application machine M. The application of the pretreatment liquid L can be followed by application of graphics to the chest and/or abdomen area A1 and the inside label/tag area A2 of the t-shirt T using the platen 10. In similar fashion to the use of the pretreatment-application machine M, the platen 10 also can be used to afford efficient application of inks and/or dyes (using one or more printing machines) to create the graphics on the chest and/or abdomen area A1 and the inside label/tag area A2 of the t-shirt T.

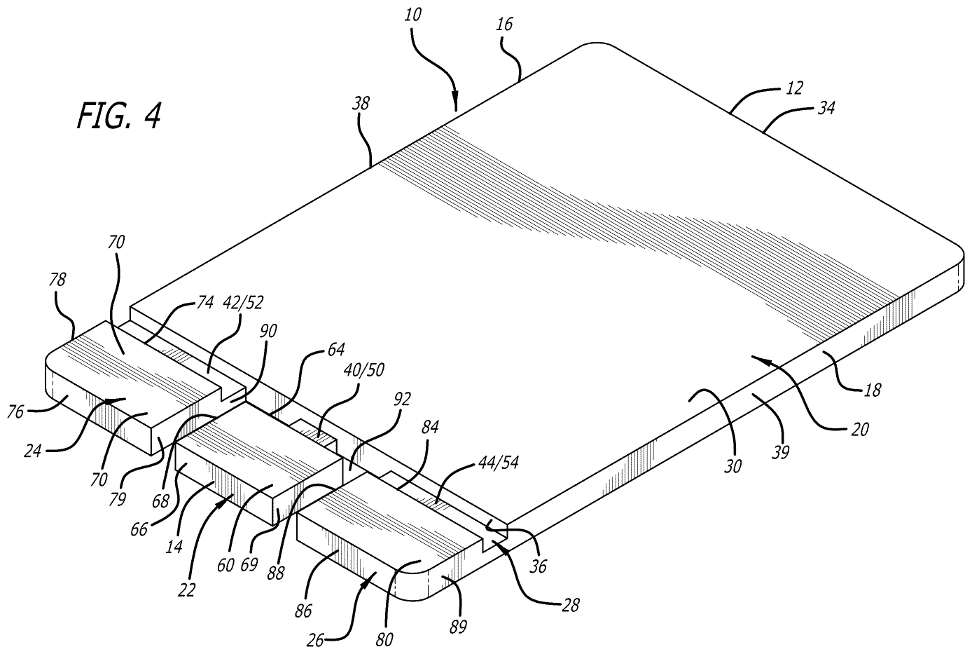

As depicted in FIGS. 4-7, the platen 10 includes a first end 12, an opposite second end 14, a first side 16 extending between the first end 12 and the second end 14, and a second side 18 extending between the first end 12 and the second end 14. Furthermore, the platen 10 includes a body portion 20, a middle extension portion 22, a first-side extension portion 24, and a second-side extension portion 26. The body portion 20 extends from the first end 12 toward the middle extension portion 22, the first-side extension portion 24, and the second-side extension portion 26, and the middle extension portion 22, the first side extension portion 24, and the second-side extension portion 26 extend from the body portion 20 to the second end 14.

The body portion 20, as depicted in FIGS. 4-7 includes an upper surface 30, a lower surface 32, a first edge portion 34 at the first end 12, a second edge portion 36 between the first end 12 and the second end 14, a third edge portion 38 along the first side 16, and a fourth edge portion 39 along the second side 18. The upper surface 30 of body portion 20 is configured to support at least a portion of the chest and/or abdomen area A1 of t-shirt T thereon. The body portion 20 can have a generally uniform thickness between the upper surface 30 and the lower surface 32, and the first edge portion 34, the third edge portion 38, and the fourth edge portion 39 can have generally uniform dimensions between the upper surface 30 and the lower surface 32.

Various connection portions extend outwardly therefrom to facilitate connection of the middle extension portion 22, the first-side extension portion 24, and the second-side extension portion 26. As depicted in FIGS. 4-7, a first connection portion 40 connects the body portion 20 and the middle extension portion 22, a second connection portion 42 connects the body portion 20 and the first-side extension 24, and a third connection portion 44 connects the body portion 20 and the second-side extension 26. The first connection portion 40 includes an upper surface 50, the second connection portion 42 includes an upper surface 52, and the third connection portion 44 includes an upper surface 54. As discussed below, the second edge portion 36 along with the upper surface 50, the upper surface 52, and the upper surface 54, and portions of the middle extension portion 22, the first-side extension portion 24, and the second side-extension portion 26 form a channel 28 for receiving portions of the t-shirt T. The channel 28 provides an at least partial gap between the body portion 20, and the middle extension portion 22, the first-side extension portion 24, and the second-side extension portion 26.

The middle extension portion 22, as depicted in FIGS. 4-7, includes an upper surface 60, a lower surface 62, a first edge portion 64 between the first end 12 and the second end 14, a second edge portion 66 at the second end 14, a third edge portion 68 extending between the first edge portion 64 and the second edge portion 66, and a fourth edge portion 69 extending between the first edge portion 64 and the second edge portion 66. Abrupt or relatively sharp corners can be formed at intersections between the first edge 64 and the second edge 66 with the third edge 68 and the fourth edge 69, and at intersections between the upper surface 60 with the first edge 64, the second edge 66, the third edge 68, and the fourth edge 69. The upper surface 60 of the middle extension portion 22 is configured to support at least a portion of the inside label/tag area A2 of the t-shirt T thereon, and can be sized so that a collar C of the t-shirt T can fit therearound. The middle extension portion 22 can have a generally uniform thickness between the upper surface 60 and the lower surface 62, and the second edge portion 66, the third edge portion 68, and the fourth edge portion 69 can have generally uniform dimensions between the upper surface 60 and the lower surface 62.

The first-side extension portion 24, as depicted in FIGS. 4-7, includes an upper surface 70, a lower surface 72, a first edge portion 74 between the first end 12 and the second end 14, a second edge portion 76 at the second end 14, a third edge portion 78 extending between the first edge portion 74 and the second edge portion 76, and a fourth edge portion 79 extending between the first edge portion 74 and the second edge portion 76. The first-side extension portion 24 can have a generally uniform thickness between the upper surface 70 and the lower surface 72, and the second edge portion 76, the third edge portion 78, and the fourth edge portion 79 can have generally uniform dimensions between the upper surface 70 and the lower surface 72.

The second-side extension portion 26, as depicted in FIGS. 4-7, includes an upper surface 80, a lower surface 82, a first edge portion 84 between the first end 12 and the second end 14, a second edge portion 86 at the second end 14, a third edge portion 88 extending between the first edge portion 84 and the second edge portion 86, and a fourth edge portion 89 extending between the first edge portion 84 and the second edge portion 86. The second-side extension portion 26 can have a generally uniform thickness between the upper surface 80 and the lower surface 82, and the second edge portion 86, the third edge portion 88, and the fourth edge portion 89 can have generally uniform dimensions between the upper surface 80 and the lower surface 82.

As depicted in FIGS. 4-7, the first connection portion 40 extends outwardly from the first edge portion 64 to facilitate attachment of the middle extension portion 22 and the body portion 20; the second connection portion 42 extends outwardly from the first edge portion 74 to facilitate attachment of the first-side extension portion 24 and the body portion 20; and third connection portion 44 extends outwardly from the first edge portion 84 to facilitate attachment of the second-side extension portion 26 to the body portion 20. The second edge portion 36 of the body portion 20, the upper surface 50 of the first connection portion 40, the upper surface 52 of the second connection portion 42, the upper surface 54 of the third connection portion 44, the first edge portion 64 of the middle extension portion 22, the first edge portion 74 of the first-side extension portion 24, and the first edge portion 84 of the second-side edge portion 26 form the channel 28.

The channel 28 is formed at least in part by depressions created by a difference in heights of the upper surface 50 of the first connection portion 40, the upper surface 52 of the second connection portion 42, the upper surface 54 of the third connection portion 44 relative to the upper surface 30 of the body portion 20, the upper surface 60 of the middle extension portion 22, the upper surface 70 of the first-side extension portion 24, and the upper surface 80 of the second-side extension portion 26. When the t-shirt T is provided over the platen 10, the channel 28, as depicted in FIGS. 1A-3, is configured to receive portions of the t-shirt T below the inside label/tag area A2 thereof, and the above-discussed difference in heights can be deep enough to receive bunched-up portions of the t-shirt T pushed thereinto.

As depicted in FIGS. 4-7, the middle extension portion 22 is separated from the first-side extension portion 24 by a gap 90 at least between the third edge portion 68 of the middle extension portion 22 and the fourth edge portion 79 of the first-side extension portion 24; and the middle extension portion 22 is separated from the second-side extension portion 26 by a gap 92 at least between the fourth edge portion 69 of the middle extension portion 22 and the third edge portion 88 of the second-side extension portion 26. When the t-shirt T is provided over the platen 10, as depicted in FIGS. 1A-3, the gaps 90 and 92 are configured to receive bunched-up portions of the t-shirt T on either side of the inside label/tag area A2 of the t-shirt T. Receipt of the bunched up portions of the t-shirt T (including portions of the collar C of the t-shirt T) adjacent the inside label/tag area A2 in the channel 28 and the gaps 90 and 92 allow more of an interior of the t-shirt T to be exposed to increase the size of the inside label/tag area A2 provided over the upper surface 60 of the middle extension portion 22. Increasing the size of the inside label/tag area A2 via such exposure affords efficient application of the pretreatment liquid L thereto.

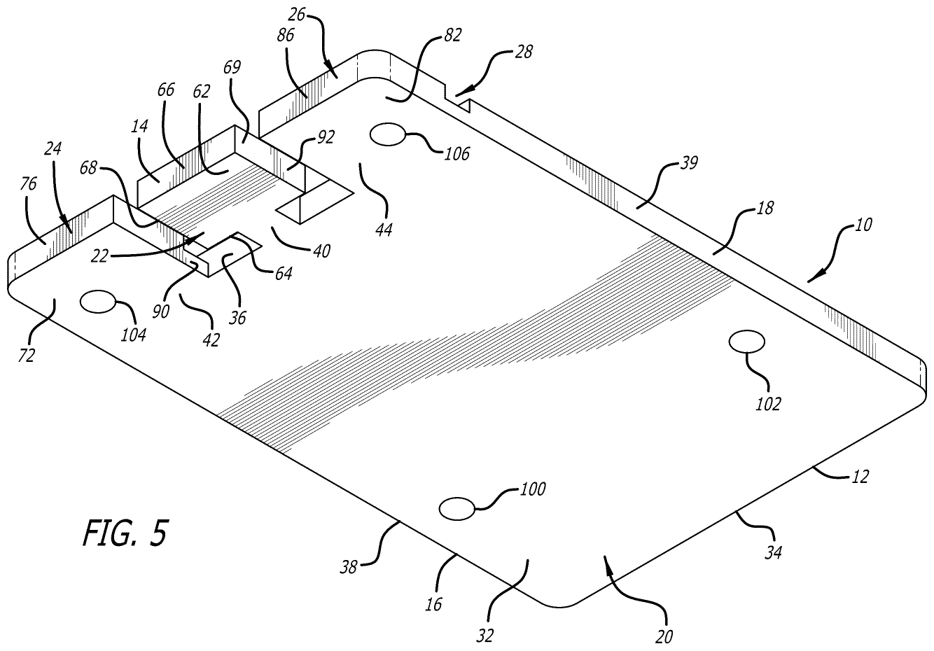

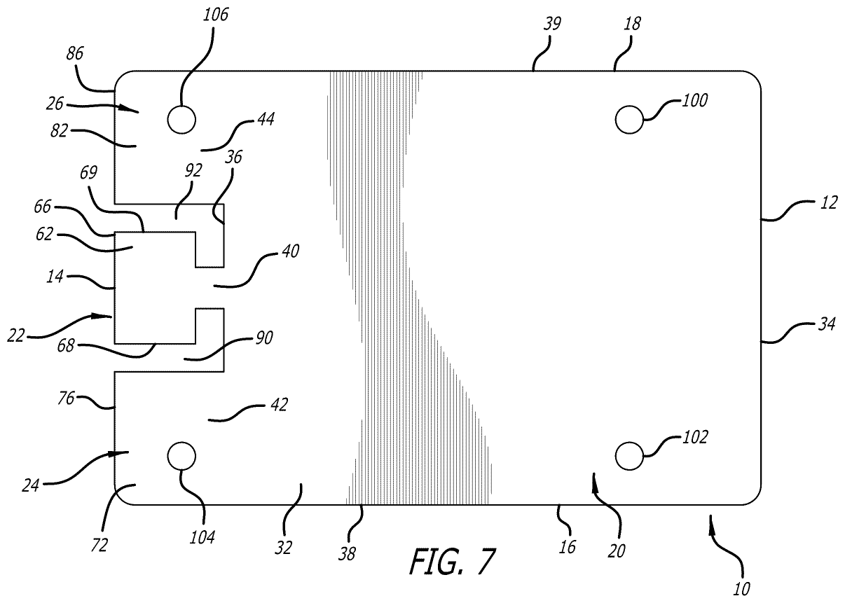

The lower surface 32 of the body portion 20, the lower surface 72 of the first-side extension portion 24, and the lower surface 82 of the second-side extension portion 26 can each have one or more apertures formed therein configured to receive one of posts P₁, P₂, P₃, and P₄ attached to the substrate S of the pretreatment-application machine M to support the platen 10 relative thereto. Post similar to the posts P₁, P₂, P₃, and P₄ can be provided on other equipment, machines, and/or stations of the printing process. As depicted in FIGS. 5 and 7, the lower surface 32 can include a first aperture 100 and a second aperture 102 formed therein, the lower surface 72 can include a third aperture 104 formed therein, and the lower surface 82 can include a fourth aperture 106 formed therein. The first aperture 100, the second aperture 102, the third aperture 104, and the fourth aperture 106 are positioned to correspond to the locations of the posts to respectively facilitate receipt of the posts P₁, P₂, P₃, and P₄ therein.

As described above, the platen 10 is formed unitarily with the body portion 20 attached to the middle extension portion 22, the first-side extension portion 24, and the second-side extension portion 26. As such, the platen 10 can be positioned and repositioned as one piece relative the pretreatment-application machine M (or other equipment, machines, and/or stations facilitating the printing process) to facilitate placement of the first aperture 100, the second aperture 102, the third aperture 104, and the fourth aperture 106 relative to the posts. However, the platen 10 is not limited to being unitary. Instead, the middle extension portion 22, the first-side extension portion 24, and/or the second-side extension portion 26 can be formed separately from the body portion 20, and can be supported separately by the posts. When the middle extension portion 22, the first-side extension portion 24, and/or the second-side extension portion 26 are formed separately from the body portion 20, these portions would be separated by gaps, rather than the channel 28. Alternatively, the middle extension portion 22 could be attached to the first-side extension portion 24 and/or the second-side extension portion 26 by connection portions similar to the first connection portion 40, the second connection portion 42, and the third connection portion 44. When so connected, channels, similar to the channel 28 would be formed between the middle extension portion 22 and the first-side extension portion 24 and between the middle extension portion 22 and the second-side extension portion 26 rather than the gaps 90 and 92, respectively.

When using the platen 10 and with the platen 10 positioned relative to the pretreatment-application machine M, as depicted in FIG. 1A, the t-shirt T can be placed on the platen 10 with the upper surface 30 of the body portion 20 supporting at least a portion of the chest and/or abdomen area A1 of t-shirt T, and with the upper surface 60 of the middle extension portion 22 supporting at least a portion of the inside label/tag area A2 of the t-shirt T. In doing so, portions of the collar C of the t-shirt T adjacent the inside label/tag area A2 are received in the channel 28 and the gaps 90 and 92. By pushing portions of the t-shirt T (including portions of the collar C) into the channel 28 and the gaps 90 and 92, more of the interior of the t-shirt can be exposed to increase the size of the inside label/tag area A2 provided over the upper surface 60 of the middle extension portion 22. Furthermore, natural elasticity of the t-shirt T (or other garment) and interaction thereof with the abrupt or relatively sharp corners formed on the middle extension portion 22 can aid in maintaining a position of the t-shirt T relative to the middle extension portion 22. Such enhancement of the size of the inside label/tag area A2 is afforded by spreading the collar C and stretching portions of the interior of the t-shirt T over the middle extension portion 22 via receipt of the portions of the t-shirt T in the channel 28 and the gaps 90 and 92. Furthermore, the receipt of the portions of the t-shirt T in the channel 28 and the gaps 90 and 92 and interaction of the t-shirt T with the abrupt or relatively sharp corners of the middle extension portion 22 can eliminate the need to use adhesives and/or tape to maintain the t-shirt T in position relative to the extension portion 22. The receipt of portions thereof in the channel 28 and the gaps 90 and 92 and corresponding interaction of with the edges of the extension portion 22 (and other surrounding portions) can hold the t-shirt T in position.

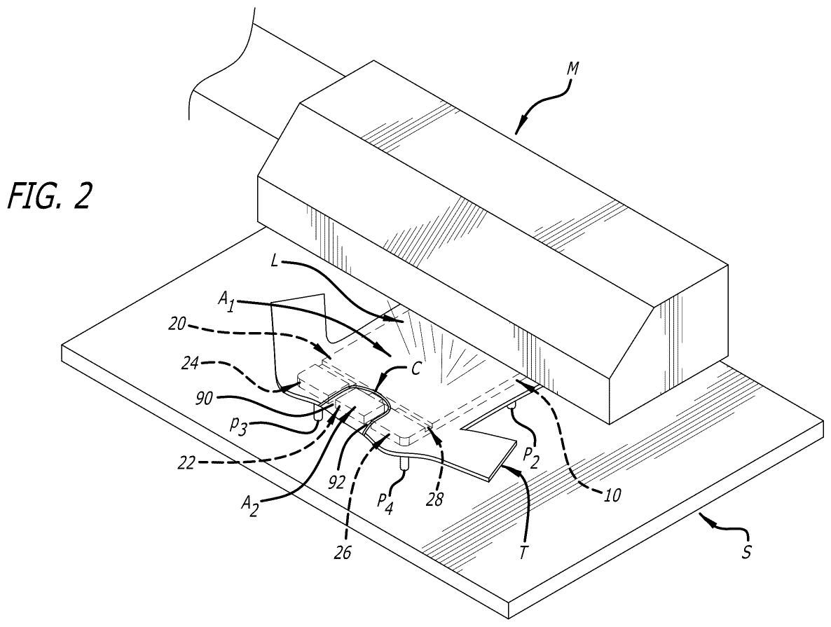

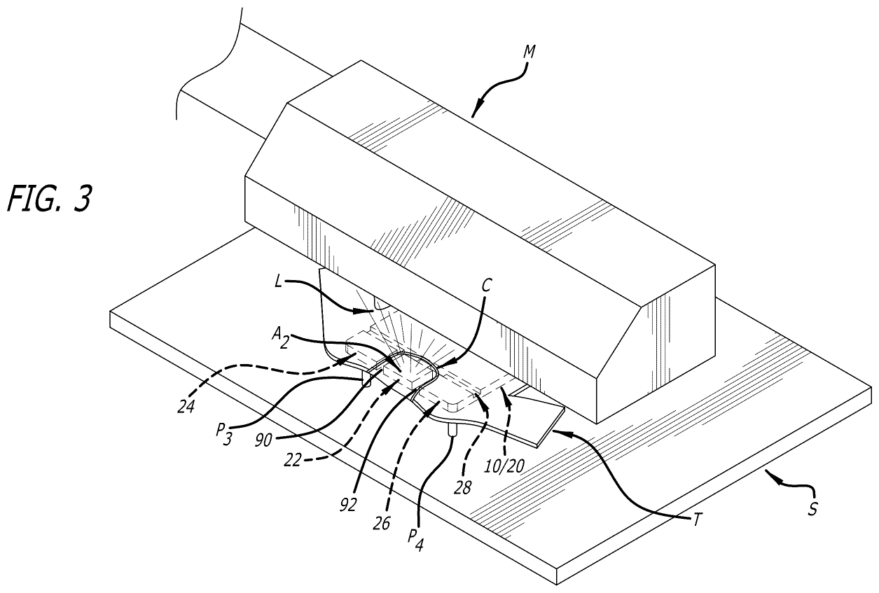

As such, when using the pretreatment-application machine M, the chest and/or abdomen area A1 of t-shirt T and the inside label/tag area A2 can be sprayed (FIG. 2) with the pretreatment liquid L. And the exposure of more of the interior of the t-shirt T by using the platen 10 increases the size of the inside label/tag area A2 on which the pretreatment liquid L can be sprayed (FIG. 3) to afford efficient application of the pretreatment liquid L thereto. Furthermore, while the platen 10 has been described as being used with the pretreatment-application machine M for application of the pretreatment L, the platen 10 is not so limited. The platen 10, for example, could be used with other equipment, machines, and/or stations such as a printing machine or machines, where an ink, inks, dye, or dyes are applied to the chest and/or abdomen area A1 and/or the inside label/tag area A2 of the t-shirt T. And the platen 10, for example, similarly could be used with other equipment, machines, and/or stations such as drying stations and cooling stations.

It should be understood that various aspects disclosed herein may be combined in different combinations than the combinations specifically presented in the description and the accompanying drawings. It should also be understood that, depending on the example, certain acts or events of any of the processes of methods described herein may be performed in a different sequence, may be added, merged, or left out altogether (e.g., all described acts or events may not be necessary to carry out the techniques). In addition, while certain aspect of this disclosure are described as being performed by a single module or unit for purposes of clarity, it should be understood that the techniques of this disclosure may be performed by a combination of units or modules associated with the platen 10 and the methods for use of the platen 10.

I/We claim:

1. A platen facilitating enhancement of a shirt label/tag area, the platen comprising:
a first end, an opposite second end, a first side extending between the first end and the second end, and a second side extending between the first end and the second end;
a body portion extending from the first end toward the second end of the platen, the body portion including an upper surface, a first edge portion positioned at the first end of the platen, and a second edge portion positioned between the first end and the second end of the platen;
a middle extension portion attached to the body portion and extending from the second end of the platen toward the body portion, the middle extension portion including an upper surface, a first edge portion opposite from the second edge portion of the body portion, a second edge portion positioned at the second end of the platen, a third edge portion positioned between the first edge portion and the second edge portion, and a fourth edge portion positioned between the first edge portion and the second edge portion;
a first-side extension portion attached to the body portion, positioned on a first side of the middle extension portion, the first-side extension portion including a first edge portion opposite from the middle extension portion;
a second-side extension portion attached to the body portion, positioned on a second side of the middle extension portion, the second-side extension portion including a first edge portion opposite from the middle extension portion;
wherein the second edge portion of the body portion and the first edge portion of the middle extension portion are spaced apart from one another by a first gap portion, the third edge portion of the middle extension portion and the first edge portion of the first-side extension portion are spaced apart from one another by a second gap portion, and the fourth edge portion of the middle extension portion and the first edge portion of the second-side extension portion are spaced apart from one another by a third gap portion; and
wherein a t-shirt can be placed on the platen with the upper surface of the body portion supporting at least a portion of a chest/abdomen area of the t-shirt, and with the upper surface of the middle extension portion supporting at least a portion of an inside label/tag area of the t-shirt.

2. The platen of claim 1, wherein portions of a collar of the t-shirt can be pushed in the first gap portion, the second gap portion, and the third gap portion to expose more of the inside label/tag area to correspondingly enhance a size of the inside label/tag area provided over the upper surface of the middle extension portion.

3. The platen of claim 1, wherein the collar of the t-shirt can be spread apart around the middle extension portion when portions thereof are pushed into the first gap portion, the second gap portion, and the third gap portion.

4. The platen of claim 1, wherein the upper surface of the middle extension portion is sized to so that the collar of the t-shirt can be fit therearound.

5. The platen of claim 4, wherein the collar of the t-shirt can be spread apart around the middle extension portion when portions thereof are pushed into the first gap portion, the second gap portion, and the third gap portion.

6. The platen of claim 1, wherein the middle extension portion includes abrupt corners at intersections of the first edge portion thereof with the third and fourth edge portions thereof, and at intersections of the second edge portion thereof with the third and fourth edge portions thereof.

7. The platen of claim 6, wherein natural elasticity of the t-shirt and interaction thereof with the abrupt corners maintains a position of the t-shirt relative to the middle extension portion.

8. A platen facilitating enhancement of a shirt label/tag area, the platen comprising:
a first end, an opposite second end, a first side extending between the first end and the second end, and a second side extending between the first end and the second end;
a body portion extending from the first end toward the second end of the platen, the body portion including an upper surface, a first edge portion positioned at the first end of the platen, and a second edge portion positioned between the first end and the second end of the platen;
a middle extension portion attached to the body portion and extending from the second end of the platen toward the body portion, the middle extension portion including an upper surface, a first edge portion opposite from the second edge portion of the body portion, a second edge portion positioned at the second end of the platen, a third edge portion positioned between the first edge portion and the second edge portion, a fourth edge portion positioned between the first edge portion and the second edge portion, and abrupt corners formed at intersections of the first edge portion thereof with the third and fourth edge portions thereof, and intersections of the second edge portion thereof with the third and fourth edge portions thereof;
a first-side extension portion attached to the body portion, positioned on a first side of the middle extension portion, the first-side extension portion including a first edge portion opposite from the middle extension portion;
a second-side extension portion attached to the body portion, positioned on a second side of the middle extension portion, the second-side extension portion including a first edge portion opposite from the middle extension portion;
wherein the second edge portion of the body portion and the first edge portion of the middle extension portion are spaced apart from one another by a first gap portion, the third edge portion of the middle extension portion and the first edge portion of the first-side extension portion are spaced apart from one another by a second gap portion, and the fourth edge portion of the middle extension portion and the first edge portion of the second-side extension portion are spaced apart from one another by a third gap portion; and
wherein a t-shirt can be placed on the platen with the upper surface of the body portion supporting at least a portion of a chest/abdomen area of the t-shirt, and with the upper surface of the middle extension portion supporting at least a portion of an inside label/tag area of the t-shirt; and
wherein natural elasticity of the t-shirt and interaction thereof with the abrupt corners maintains a position of the t-shirt relative to the middle extension portion.

9. The platen of claim 8, wherein portions of a collar of the t-shirt can be pushed in the first gap portion, the second gap portion, and the third gap portion to expose more of the inside label/tag area to correspondingly enhance a size of the inside label/tag area provided over the upper surface of the middle extension portion.

10. The platen of claim 8, wherein the collar of the t-shirt can be spread apart around the middle extension portion when portions thereof are pushed into the first gap portion, the second gap portion, and the third gap portion.

11. The platen of claim 8, wherein the upper surface of the middle extension portion is sized to so that the collar of the t-shirt can be fit therearound.

12. The platen of claim 11, wherein the collar of the t-shirt can be spread apart around the middle extension portion when portions thereof are pushed into the first gap portion, the second gap portion, and the third gap portion.

13. A method of using a platen with a shirt label/tag area enhancement, the method comprising:
providing the platen having a body portion having an upper surface, a middle extension portion attached to the body portion, a first-side extension portion attached to the body portion and provided on a first side of the middle extension portion, and a second side-extension portion attached to the body portion and provided on a second side of the middle extension portion;
supporting the t-shirt on the platen by placing a portion of a chest/abdomen area of the t-shirt on an upper surface of a body portion of the platen and placing a portion of an inside label/tag area of the t-shirt on an upper surface of the middle extension portion of the platen;
pushing portions of a collar of the t-shirt into a first gap portion between the body portion and a middle extension portion, into a second gap portion between the middle extension portion and the first-side extension portion, and into a third gap portion between the middle extension portion and the second-side extension portion to expose more of the inside label/tag area to correspondingly enhance a size of the inside label/tag area provided over the upper surface of the middle extension portion; and
when the t-shirt is supported on the platen, positioning the platen and the t-shirt positioned thereon in a pretreatment-application machine, and spraying a pretreatment over portions of the chest/abdomen area and the inside label/tag area of the t-shirt using the pretreatment-application machine.

14. The method of claim 13, further comprising spreading the collar of the t-shirt around the middle extension portion when portions thereof are pushed into the first gap portion, the second gap portion, and the third gap portion.

15. The method of claim 13, wherein the upper surface of the middle extension portion is sized to so that the collar of the t-shirt can be fit therearound.

16. The method of claim 15, further comprising spreading the collar of the t-shirt around the middle extension portion when portions thereof are pushed into the first gap portion, the second gap portion, and the third gap portion.

17. The method of claim 13, wherein the middle extension portion includes at least a first edge portion, a second edge portion, a third edge portion, and abrupt corners formed at intersections of the first edge portion with the second and third edge portions; and further comprising maintaining a position of the t-shirt relative to the middle extension portion via interaction of natural elasticity of the t-shirt with the abrupt corners.

18. The method of claim 17, further comprising removing the platen and the t-shirt positioned thereon from the pretreatment-application machine, and repositioning the platen and the t-shirt positioned thereon in a printing machine.

19. The method of claim 18, further comprising printing graphics on both the chest/abdomen area and the inside label/tag area of the t-shirt using the printing machine.

20. The method of claim 19, further comprising removing the platen and the t-shirt positioned thereon from the printing machine, and repositioning the platen and the t-shirt provided thereon in at least one of a drying machine and a cooling machine.
